(19) United States
(12) Patent Application Publication
(10) Pub. No.: US 2021/0010896 A1
(43) Pub. Date: Jan. 14, 2021

(54) METHOD FOR MONITORING AT LEAST ONE MEASUREMENT OF THE STRUCTURAL STATE OF A BUILDING

(71) Applicant: PERENNEA DEVELOPPEMENT, Narbonne (FR)

(72) Inventors: Jean-Luc JALABERT, Narbonne (FR); Jessy ADELL, Narbonne (FR)

(21) Appl. No.: 17/042,293

(22) PCT Filed: Mar. 28, 2019
(86) PCT No.: PCT/FR2019/000041

§ 371 Date: Sep. 28, 2020

(30) Foreign Application Priority Data
Mar. 28, 2018 (FR) 1852696

(51) Int. Cl. G01M 5/00; G01B 7/16

(52) U.S. Cl. CPC G01M 5/0066; G01M 5/0033; G01B 11/16; G01B 7/18; G01M 5/0083

(57) ABSTRACT

The device for measuring the structural state of a building a device for measuring the movement and/or vibration of a reference module in relation to a target in accordance with a three-axis reference system. To this end, the device for measuring includes a resilient polymer cable which conducts with variable resistivity and a vibration sensor which measures the vibrations of the building. The invention also relates to a method for monitoring at least one measurement of the structural state of a building and an installation which incorporates at least one measuring device.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to the field of monitoring the development of the stresses to which a structure or building is subject, such as vibrations or cracking phenomena.

More particularly, the present invention relates to a method for monitoring at least one measurement of the structural state of a building, as well as an installation for implementing said method and a measuring device comprised in such an installation.

### 2. Description of Related Art Including Information Disclosed Under 37 CFR 1.97 and 37 CFR 1.98.

Whatever the structure or construction considered, it was built on a base having characteristics that may change over time, whether due to geological, climatic or other phenomena. Said changes are bound to affect said structure or construction, not to mention that it may also be subject to various constraints, vibrations, changes in load, or temperature variations that are not necessarily dependent on the characteristics of the support on which said structures or constructions rest.

In particular, such structures or constructions are subject to cracking phenomena, the development of which must be monitored in order to analyze their impact on the strength and solidity of the building.

On this subject, “potentiometric” measuring devices are already known that allow periodic readings to be taken of the developing spread of a crack.

In particular, this type of device is known from document WO 2006/120435 in the form of an inductive transmitter and receiver secured on either side of a crack. This type of device may operate with other environmental sensors that allow, for example, humidity, temperature, strength, conductance, vibrations or atmospheric pressure to be measured, on the understanding that all the information read by means of said device and/or said sensors may be sent via a telecommunications network and suitable transmission means to a remote processing unit.

Similarly, another crack monitoring device for a wall is known from document WO 2012/025763 which takes the form of a crack elongation sensor formed by at least one magnetic field sensor arranged on one side of the crack and a magnet on the other. In this document, provision is also made for the device possibly to comprise a plurality of said magnetic field sensors, so as to measure the development of the crack in a number of directions.

As in the previous document, the device described here comprises means of remotely transmitting the data collected to a processing unit. However, such magnetic field sensors cannot be used to monitor a building that has a metal structure.

Also known from document WO 2013/007720 is a vibration and crack monitoring device for a wall in the form of two modules fastened, one on one side and the other on the other side of a crack. The first module, provided with an electronic card, comprises an arm linked to another module via an elongation sensor formed by a potentiometric membrane. More particularly, the second module comprises a slide element in mechanical or electrical contact with the potentiometric membrane.

Although in this document, as in all the other documents of the prior art, remote transmission means for the measurements taken are provided, it will be noted that said measurements are transmitted systematically and directly by the device in question to a remote processing unit. In addition, each of said devices must be provided with transmission means suited to the distance separating said means from said data processing unit.

In particular, unless said unit is devised to be installed close to said measuring device, said measuring device must be provided with GSM or other transmission means for long-distance data transmission. This makes the measuring device in question considerably more complex, not to mention that the autonomous power supply means must be appropriately sized if regular replacement and/or recharging thereof is to be avoided.

A solution to respond to said problem of autonomy consists, clearly, of connecting the measuring devices to an electricity supply network provided that such a power supply is present on-site, not to mention the increased risks of said power supply being cut off.

Moreover, all said potentiometric measurement solutions, whether by magnetic field or using a lead of which the resistance changes on being extended are only relatively precise, being dependent on various environmental factors such as temperature, humidity or the surrounding materials. Moreover, the measurement travel of the potentiometric sensors requires space and although some are capable of giving movement information in two directions, access to information on movements in three axes is only possible by splitting said potentiometric sensors.

Moreover, as mentioned, in particular in view of the prior art relating to document WO 2006/120435, the crack monitoring devices must be combined with other types of sensors if more precise information on the development of a crack is to be obtained. Thus, for example, the addition of an accelerometer, a gyroscope, etc. is useful to collect information on the speed of the movements noted.

### BRIEF SUMMARY OF THE INVENTION

It is to overcome all said drawbacks and others that will appear later in the description that the applicant has developed the present invention.

A first aspect of the invention relates to a device for measuring the structural state of a building comprising at least one reference module, and means for measuring the movement of a target relative to the reference module, the measuring means comprise means for detecting the movement of the target in a three-axis reference system.

The measuring device is characterized in that it comprises a vibration sensor measuring the vibrations of the building, the movement measuring means comprising a resilient polymer cable which conducts with variable resistivity, the polymer cable, while being kept under voltage, connects the reference module and the target, moreover, at least one reference module and/or the target comprises at least one resistivity sensor cooperating with the polymer cable.

By means, on the one hand, of a resistivity sensor cooperating with a polymer cable as claimed, and on the other hand, a vibration sensor, it is possible to measure, at a given moment:

the distance and extent of the movement of a reference module relative to the target in a three-dimensional frame of reference, and

the vibrations of the building, likewise in a three-dimensional frame of reference.

The subsequent correlation of these data allows the structural state of a building to be monitored.

According to a first characteristic of the first aspect of the invention, the measuring device comprises a protection sheath providing a confined measuring space in which the polymer cable extends.

According to a second characteristic of the first aspect of the invention, the reference module and/or a target comprise a fastening support for secure fastening thereof to a wall of the building of which the structure needs monitoring.

According to a third characteristic of the first aspect of the invention, the target is formed by a fastening support or by a target module.

According to a particular feature of the invention, if the target is formed by a fastening support, with the measuring means comprising an electric information return cable which is connected to the polymer cable and extends between the fastening support, the electric cable is rolled around the polymer cable or incorporated in the protection sheath.

However, if the target is formed by a target module, information is returned by a resistivity sensor. Said resistivity sensor is incorporated in the target module in the region of the attachment point of the polymer cable.

According to the invention, a module is defined by a rigid casing which is impervious to water and to air. Preferably, the casing is designed in the form of two half-shells rigidly connected to one another.

A second aspect of the invention relates to a method for monitoring at least one measurement of the structural state of a building that uses at least one measuring device according to the first aspect of the invention.

The method is characterized in that it comprises:

a step of parameterizing an initial state of at least one measuring device incorporating at least one vibration and/or movement sensor, each measurement producing data;

a step of periodically reading at least one vibration and/or movement measurement by means of at least one measuring device incorporating at least one vibration and/or movement sensor, each measurement producing data;

a step of periodically transmitting the data produced to at least one remote processing unit of the measuring device;

a step of comparing the vibration and/or movement data to the initial state of the measuring device; and

a warning step, if the vibration and/or movement data exceed a given threshold difference compared to the initial state of a measuring device.

According to a second characteristic of the first aspect of the invention, the monitoring method comprises a step of coding the data allowing the provenance of the data recorded to be identified according to:
the measuring device from which said data come;
the sensor that measured said data; and
the moment T at which said data were measured.

According to a third characteristic of the first aspect of the invention, the monitoring method comprises a data sorting step so as to arrange said data according to:
the measuring device from which said data come;
the sensor that measured said data; and
the moment T at which said data were measured.

A third aspect of the invention concerns an installation for monitoring the structural state of a building, characterized in that it comprises, on the one hand, at least one measuring device according to the first aspect of the invention, the at least one measuring device being provided with remote transmission means, and on the other hand, a remote processing unit of the measuring device, the processing unit being suitable for receiving and classifying the data transferred according to:
the measuring device from which said data come;
the sensor that measured said data; and
the moment T at which said data were measured.

According to a particular feature of the third aspect of the invention the measuring device comprises at least one reference module associated with a target, the reference module and the target being connected by means of the polymer cable, whereas the target is formed by a target module or a fastening support.

According to a variant of the third aspect of the invention, the installation comprises a relay unit (15) comprising:
a receiver (16) for the data sent by the transmission means (14) of at least one measuring device (11);
means (17) for recording the data transmitted;
means (18) for remotely transferring the data; and
autonomous electric power supply means (19) and/or connection means (20) to an external electric power supply.

Other particular features and advantages will appear in the detailed description that will follow relating to embodiments given as indicative and non-limiting examples.

### BRIEF DESCRIPTION OF THE SEVERAL VIEWS OF THE DRAWINGS

Said description will be understood more easily on referring to the accompanying drawings.

FIG. 1 is a diagram showing a method for monitoring the structural state of a building according to the invention.

FIG. 2 is a schematic view of a diagram showing an installation for implementing the method in FIG. 1.

FIG. 3 is a schematic view of a diagram showing a measuring device comprising optical movement measuring means in the form of a laser transmitter/receiver.

FIG. 4 is a schematic view of a diagram showing a measuring device comprising movement measuring means in the form of a conductive polymer cable extending between a reference module and a target module.

FIG. 5 shows a schematic view of a measuring device according to FIG. 4.

FIG. 6 is a schematic view of a diagram showing means for adjusting the precision of the measuring device of FIG. 4.

FIGS. 7 to 12 are schematic views, showing various possible ways of attaching the measuring device of FIG. 4 according to the structural configuration of a building.

FIG. 13 is a schematic view of a diagram showing a measuring device suitable for measuring the vibrations of a building.

FIGS. 14 to 17 show schematic views of different possible installations of the invention.

FIG. 18 shows a schematic view of a measuring device installed on a billboard.

FIG. 19 shows a schematic view of an installation for monitoring a bridge or viaduct comprising a plurality of measuring devices.

### DETAILED DESCRIPTION OF THE INVENTION

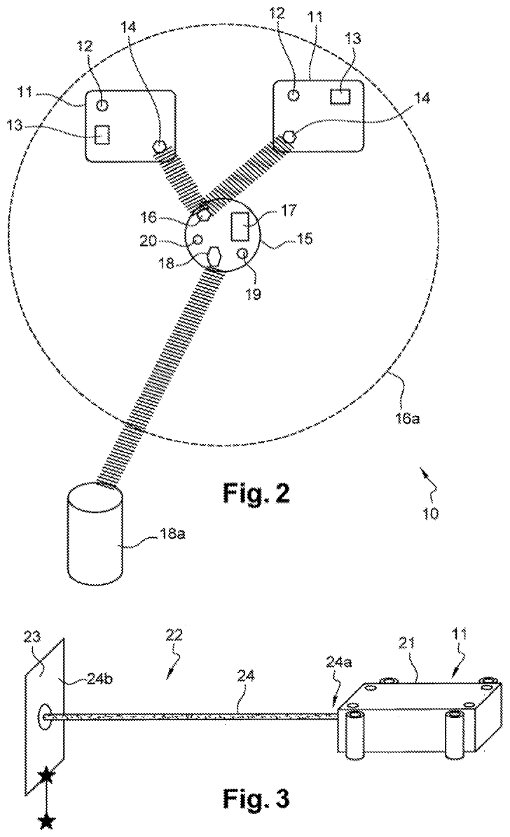

As shown in FIG. 2, the invention relates to an installation 10 for implementing a method for monitoring the structural state of a building.

Accordingly, the installation 10 comprises at least one measuring device 11 comprising autonomous electric power supply means 12. The autonomous electric power supply means 12 supply power to at least one vibration and/or movement sensor 13, and the means 14 for remote transmission of the data produced by the sensor(s) 13.

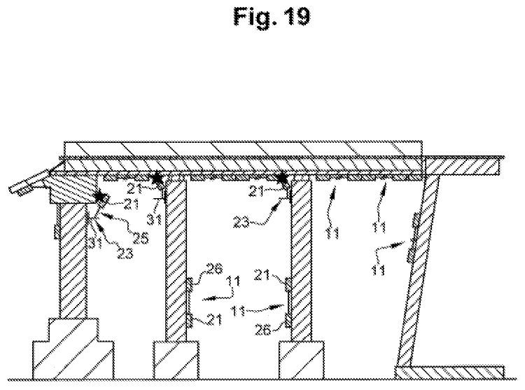

In the example shown in FIG. 2, this type of installation 10 may therefore be provided with a plurality of measuring devices 11 placed at different locations on the building(s) of which the structural state needs monitoring (shown in FIG. 19).

According to a variant of the invention, the installation 10 may comprise at least one relay unit 15 which comprises a receiver 16 for the data transmitted by the transmission means 14 of the measuring device(s) 11. The receiver 16 is configured to receive data coming from one or more measuring device(s) 11 situated within a given reception sphere 16a.

According to this variant, the receiver 16 cooperates with the transmission means 14 so as to form a complementary transmitter/receiver group. Accordingly, the transmission means 14 and the receiver 16 are preferably of the radiofrequency type, owing in particular to their simplicity of design, reliability and low energy consumption.

The relay unit 15 may also comprise means 17 for recording the data transmitted by the measuring device(s) 11. These recording means 17 may be in the form for example of an EEPROM memory associated with a suitable microcontroller.

Said relay unit 15 also comprises remote transfer means 18 allowing the data recorded to be transmitted periodically to one or more remote processing units 18a.

Said remote transfer means 18 may also be of the radiofrequency type and will preferably be better suited to secure long-distance transmission to the remote processing unit 18a.

Thus, said remote transfer means 18 may take the form of an Internet network connection card and/or any suitable intercommunication system such as a GSM network. Preferably, the relay unit 15 incorporates a plurality of remote transfer means 18 these being differentiated by the transmission mode (wireless or not), or the transmission protocol (SMS, MMS, etc.).

However, according to another variant of the invention, the transmission means 14 transmit the data generated by the measuring device 11 directly to the remote processing unit 18a. Accordingly, the transmission means 14 may be in the form of an Internet network connection card and/or any suitable intercommunication system such as a GSM network.

According to this variant, the measuring device 11 may also comprise a memory in order to store the data generated locally. Advantageously, the installation 10 may be used on an edifice, such as a bridge situated far from any Internet network, as some intercommunication networks have very poor reception. By incorporating different remote transfer means 14, 18, the installation 10 according to the invention can be made functional in most of the situations encountered.

In this regard, the relay unit 15 preferably comprises, as well as a measuring device 11, autonomous electric power supply means 19. The autonomous electric power supply means 19 may also be combined with connection means to an electric power supply from an external network. The relay unit 15 may also be connected to renewable energy production means such as photovoltaic panels installed on-site.

According to another particular feature of the present invention, a measuring device 11 comprising at least one vibration and/or distance sensor 13 comprises at least one reference module 21. The measuring device 11 is also provided with means 22 for measuring the movement of the reference module 21 relative to a target 23.

According to a first embodiment shown in FIG. 3, the movement measuring means 22 are optical measuring means. In this example, said optical movement measuring means 22 are defined by a laser beam transmission 24a and reception 24b system 24. In particular, this type of movement measuring means 22 formed by a laser beam system 24 allow a movement of the target 23 toward which the laser beam 24 is directed in three axes X, Y, Z to be easily determined.

Thus, applied to the behavior of a crack, by placing the reference module 21 on one side of the crack, a target 23 on the other side of the crack, this type of laser beam system 24 is capable of monitoring the behavior and development of said crack in three axes X, Y, Z. Advantageously, it is possible to measure a spreading and/or reduction of the crack. Measurement in three axes also allows any radial and/or transverse mismatch of the walls A adjoining the crack to be measured.

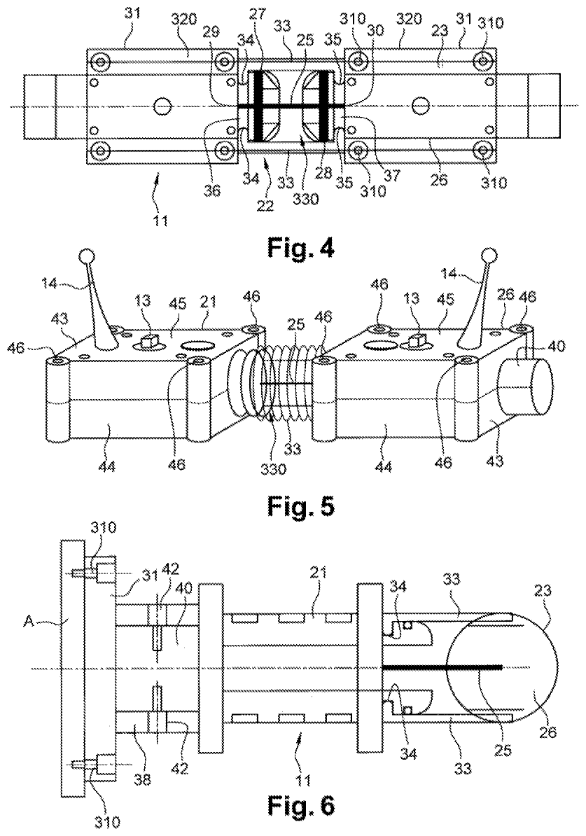

According to another embodiment shown in FIGS. 4 to 11, the movement measuring means 22 comprise at least one resilient polymer cable 25 which conducts with variable resistivity. The resistivity of the polymer cable 25 varies according to the deformation and/or voltage thereof between the reference module 21 and the target 23. Thus, monitoring the electric activity of the polymer cable allows the gap between the reference module 21 and the target 23 to be measured. It is also possible to measure vibrations that occur in the longitudinal axis of the polymer cable 25. Moreover, the extent to which the polymer cable 25 is extended and/or the intensity of the vibrations thereof may also be evaluated by the variation in the voltage of the electric potential of the polymer cable 25.

In the case of FIGS. 4 to 12 and 16 to 19, the target 23 is in the form of a target module 26.

Preferably, at least one reference module 21 and/or a target module 26 comprises at least one resistivity sensor 27, 28. A resistivity sensor 27, 28 cooperates with the polymer cable 25 at one and/or the other of the fastening ends 29, 30 thereof. Each fastening end 29, 30 of the polymer cable 25 is fastened in the region of the reference module 21 and of the target module 26.

Advantageously, the measuring device 11 comprises a protection sheath 33 for the polymer cable 25. The protection sheath 33 ensures measurement without external disturbance and protects the polymer cable 25 from bad weather.

To sum up, the polymer cable 25 extends inside a confined measuring space 330 which is provided by the protection sheath 33. Moreover, the protection sheath 33 is also inserted and fastened at the ends 34, 35 in reception end pieces 36, 37. The reception end pieces 36, 37 are arranged in the region of the reference module 21 and the target module 26, respectively. Each resistivity sensor 27, 28 is arranged in the region of a reception fitting 36, 37 of a reference module 21 and/or a target module 26.

This type of protection sheath 33 is flexible, to follow the movements of the reference module 21 and the target module 26 freely.

Moreover, a reference module 21 and, if appropriate, the target module 26 comprise a fastening support 31 allowing said modules to be securely connected to a wall A of the building of which the structure must be monitored.

In the embodiment shown in FIGS. 4 to 11, the fastening supports 31 are in the form of fastening plates 320 provided with through-openings for fastening screws 310.

As shown in FIGS. 10 and 11, the fastening supports 31 may comprise two plates hinged to one another via a pin 321. In this configuration, the angular position of one fastening plate 320 relative to the other may be locked using tightening means cooperating with the pin 320.

Advantageously, a reference module 21 and/or a target module 26 is mounted removably on its fastening support 31. This configuration allows the fastening support 31 of the building to be rigidly connected, with no risk of a module 21, 26 being modified in the course of this operation.

However, this removable character must not produce a loss of precision in the measurements taken. In particular, a module 21, 26 must be precisely positioned in the reference system forming the fastening support 31 thereof.

Accordingly, the fastening support 31 may comprise female or male insertion means 38 for receiving a complementary male or female insertion part 40 comprised in a module 21, 26. The insertion means 38 and the complementary insertion part 40 correspond to an adjustment system adapted to the precision sought. For example, the insertion length is defined according to the level of precision required to position a module 21, 26 on its fastening support 31.

In particular, and as shown in FIG. 5, the female insertion means 38 may be defined in the form of a socket in which the complementary male insertion part 40, 41 is inserted. The complementary male insertion part 40 may be defined by an end piece with a cross section adapted to the internal cross section of a socket. In practice the end piece cross section is adapted to the internal cross section of the socket over an insertion length corresponding to at least half the cross section of the end piece, or is even equal to said cross section. The insertion means 38 and the insertion part 40 also have suitable tightening means 42.

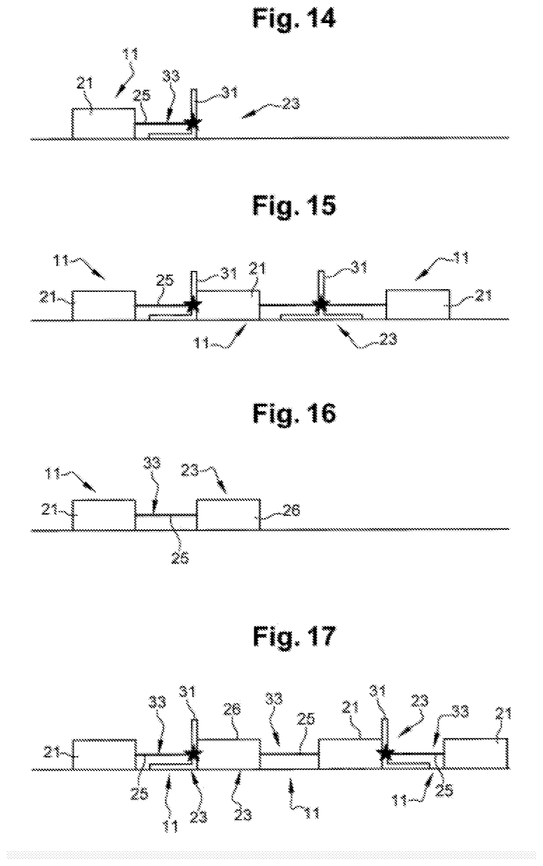

As shown in FIGS. 14, 15 and 19, the target 23 may be formed by a fastening support 31. In these figures, the fastening support 31 is in the form of a bracket.

In this configuration, the measuring means 22 may comprise an electric information return cable. Said electric cable allows data on the variation in resistivity of the polymer cable 25 to be sent back to a resistivity sensor 27, 28 of the reference module 21. Said electric cable also allows a resistivity sensor 27, 28 to measure data relating to the voltage of the electric current passing through the polymer cable 25.

The electric cable is connected to a fastening end 29, 30 of the polymer cable 25. Said electric cable is rolled around the polymer cable 25 or incorporated in the protection sheath 33. This arrangement allows said electric cable to join the other fastening end 29, 30 of the polymer cable 25 where a resistivity sensor 27, 28 of the reference module 21 is situated.

Still with the same object of optimizing the precision of the measurements taken, a module 21, 26 may be defined by a rigid casing 43. For example, the casing is designed in the form of two half-shells 44, 45 rigidly connected to one another. The two half-shells enclose all the necessary electronic and mechanical components. Preferably, the casing 43 is made watertight and airtight.

As shown in FIG. 5, the casing 43 is provided with recessed holes 46 in order to fasten the casing 43 to a fastening support 31 or directly to a wall A. More particularly, each half-shell 44, 45 comprises four recessed holes 46 arranged at each corner of an upper and a lower face of the casing 43.

Advantageously, the design of the fastening supports 31 and of the casing 43 allow a reference module 21 and a target module 26 to be connected whatever the orientation of the walls A adjoining the crack that must be monitored.

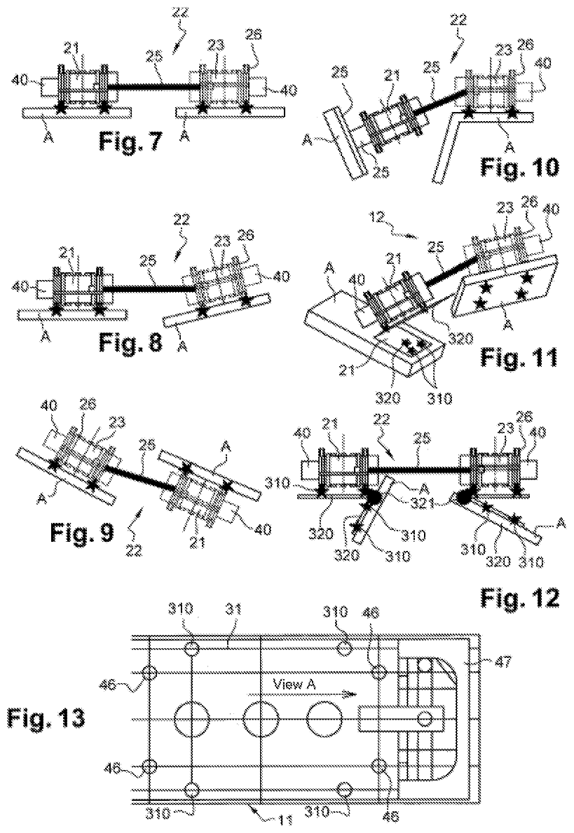

It is therefore possible to monitor the development of a crack comprised between two coplanar walls A (FIG. 7), but also between two walls A that are parallel to one another (FIG. 9) or between two walls A extending in two intersecting planes (FIGS. 8, 10, 11 and 12).

According to the invention, this type of module 21, 26 may also enclose many other sensors 13 such as temperature, pressure, humidity sensors or even movement sensors such as a three-axis gyroscope and/or a three-axis accelerometer or a magnetic field sensor.

Advantageously, the data measured by said sensors 13 allow environmental parameters to be measured. The data from the environmental parameters may be correlated with the measurements for monitoring the development of a crack. It is therefore possible to create a dynamic digital model of the structural state of the building.

In particular, it is possible to create a dynamic digital model of a crack according to the environmental parameters to which the building being monitored is subject.

Said environmental parameters may also provide direct information on the development of the crack.

The magnetic field sensor allows a change in the magnetic field close to the crack to be measured. Said change may be due to a module 21, 26 moving, scrap iron being uncovered or degraded, coming closer to a metal structure, etc.

The temperature sensor or the atmospheric pressure sensor allows changes in a crack or in the structural state of the building to be correlated with atmospheric conditions.

Finally, the movement sensors allow the vibrations in the building and their intensity and duration to be measured. These data may also be correlated with the change in the structural state of the building and/or of a crack.

Of course, the measuring device 11 has electronic means. The electronic means are supplied with power by the autonomous electric power supply means 12.

The electronic means allow the measurements of the different sensors 13, 27, 28 equipping the measuring device 11 to be synchronized. The electronic means also record the data generated in the memory of the measuring device 11. Finally, the electronic means allow the actuation of the transmission means 14 to be controlled in order to transfer the data generated to a remote processing unit 18a or to a relay unit 15.

Accordingly, in a conventional manner, the electronic means may comprise a processor equipped with a clock. The processor is configured to execute algorithms stored in the memory of the measuring device 11.

In the example in FIG. 13, the measuring device 11 comprises a stopper 47 to hermetically seal said device against air and water. In this example, the measuring device 11 is used to monitor the structural state of a building by means in particular of said vibrational and/or environmental sensors 13. This embodiment may be used to monitor the behavior of a structure such as a billboard, football goals or a basketball backboard.

Moreover, the measuring device 11 comprising remote transmission means 14 to transmit the measurements taken using said sensor(s) 13 to the relay unit 15 or to a remote processing unit 18a. These remote transmission means 14 are installed in the casing 43 corresponding to a reference module 21 and/or to a target module 26. The same applies to the autonomous power supply means 12.

If a reference module 21 and a target module 26 can each be equipped with such transmission means 14 and autonomous electric supply means 12, a sealed wire connection between a target module 26 and the reference module 21 may also be provided. In this case, the measuring device 11 may simply have transmission means 14 and autonomous electric power supply means 12 only installed in a single module 21, 26, for example, in the reference module 21.

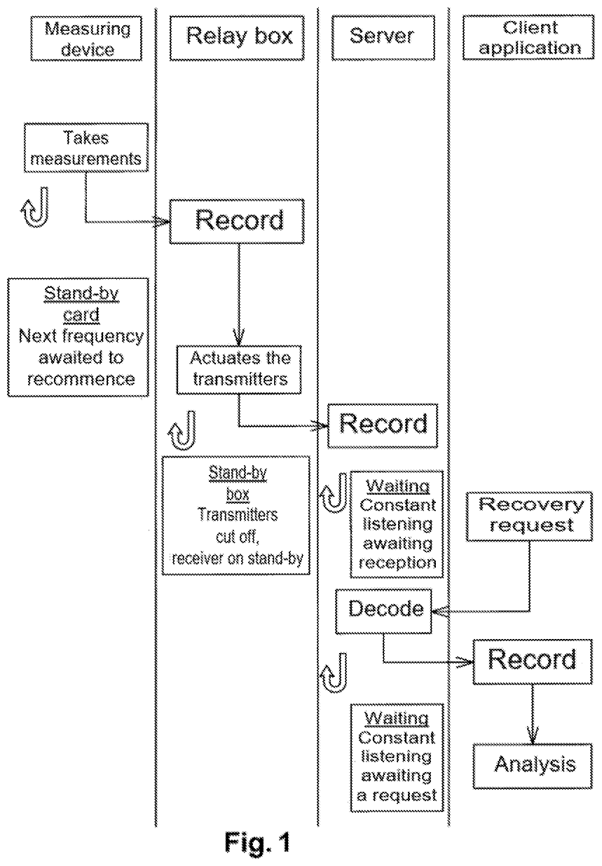

According to the invention, the installation 10 allows a monitoring method, illustrated in FIG. 1, to be implemented.

In general, the monitoring method is managed by the electronic means of the measuring device 11. Said electronic means may be parameterized by the user according to the building to be monitored and the parameter(s) to be measured. Thus, the monitoring method allows at least one measurement of the structural state of a building to be monitored.

Accordingly, the monitoring method comprises a step of parameterizing an initial state of at least one measuring device 11. As mentioned earlier, each measuring device 11 may incorporate at least one vibration sensor 13 and/or movement measuring means 22. The measurements taken by said instruments produce data relating to the state of the structure of the building. However, the measurements taken during the parameterization step are comparable to standard measurements characterizing the initial state of the measuring device 11.

The standard measurements are stored locally and/or transmitted to a remote processing unit 18a which stores said data as the initial state of the measuring device 11.

The monitoring method comprises a step of periodically reading at least one vibration and/or movement measurement by means of at least one measuring device 11 incorporating at least one vibration sensor 13 and/or movement measuring means 22.

As described earlier, a measuring device 11 may incorporate various sensors 13 allowing vibration, movement, acceleration, temperature, atmospheric pressure, humidity etc. to be measured.

The monitoring method comprises a step of coding the data. Each measurement produces coded data in the form of coded rows of octets. Each coded row of octets comprises a first sequence of octets which forms a signature of the measuring device 11. The signature of the measuring device 11 allows the measuring device 11 that produced said coded data to be identified.

The coded data also comprise a second sequence of octets allowing the moment T when each measurement was taken to be identified. As would be expected, each row of octets comprises sequences of octets relating to the type of sensor 13 equipping the measuring device 11 that took the measurement.

The monitoring method may comprise a step of storing the coded data locally in the memory of the measuring device 11. More generally, the data generated are stored locally in the memory of the measuring device 11.

The method also comprises a step of periodically transmitting the coded data to at least one relay unit 15 or directly to a processing unit 18a. It should be noted that said transmission periodicity of the measuring device(s) 11 may correspond to the measurement reading periodicity.

If the user chooses to transfer the data generated to a relay unit 15, said relay unit 15 is parameterized to receive the coded data from one or more measuring device(s) 11 situated in a given reception sphere 16a. The reception sphere 16a has a radius of between 50 meters and 500 meters, the reception sphere 16a preferably comprises a radius of between 100 meters and 200 meters.

If the data generated are transmitted to a relay unit 15, it is possible for said data to be stored in the memory of the measuring device 11 or in the relay unit 15. In the second possible scenario, on receiving the coded data, the relay unit 15 then performs a step of recording the raw coded data transmitted. In practice, the raw data recording step is carried out in the memory equipping the relay unit 15.

The monitoring method may therefore comprise a step of periodically transferring the coded data recorded by the relay unit 15 to at least one remote processing unit 18a. Here too, the periodicity of sending said coded data recorded by the relay unit 15 to the processing unit 18a may correspond to the periodicity at which the measurements of the measuring device(s) 11 are transmitted to the relay unit 15.

Preferably, said relay unit 15 will send said recorded data to the processing unit 18a at a lower frequency. The reduction in frequency means that the remote transfer means 18 with which the relay unit 15 is equipped are loaded less often.

During the step of transferring data to the processing unit 18a, a test operation is performed to transmit data via the remote transfer means 18 and/or by the most suitable transfer protocol. This characteristic allows for functional and reliable implementation of the installation 10 wherever said installation is set up.

The processing unit 18a performs a step of locally recording the coded data transferred by the relay unit 15 or directly by the measuring device 11. In practice, the processing unit 18a records the coded data transmitted by the measuring device(s) 11 or via one or more relay unit(s) 15 in a local memory.

The method comprises a step of decoding the coded data which is carried out by the processing unit 18a. The decoding step allows a sorting step to be carried out to organize the data. The data are therefore organized according to the measuring device 11 from which said data originate, the type of sensor 13 that took the measurement and the moment T when the measurement(s) were taken.

Accordingly, the processing unit 18a uses the sequences of octets corresponding to the signature of the measuring device 11, the type of sensor 13 that took the measurement and the moment T at which the measurement was taken.

The method according to the invention may comprise a step of cross checking the decoded data allowing the different phenomena that were measured at a moment T to be linked.

Moreover, the monitoring method has a step of comparing the vibration and/or movement data measured at a moment T to the data in the initial state of the measuring device 11.

The monitoring method comprises a warning step. The warning step allows the user to be warned if the vibration and/or movement data measured at a moment T exceed a given threshold difference compared to the initial state of a measuring device 11.

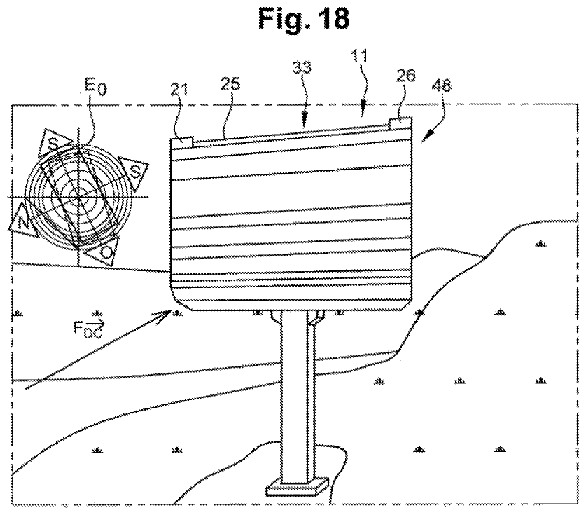

FIG. 18 shows a traffic sign 48 on which a measuring device 11 is positioned. More specifically, the measuring device is positioned on the upper field of the traffic sign 48. In this example, the measuring device 11 comprises a reference module 21 and a target module 26. A polymer cable 25 extends between the two modules 21, 26. It should be noted that the protection sheath 33 is not shown here in order to simplify the reading of the drawing.

Following a parameterization step, an initial state E0 is determined (shown in the upper corner of FIG. 18). If a force F^{→}_{DC} is applied to the traffic sign 48, said sign begins to vibrate and/or the position/slope thereof is modified compared to the initial state thereof E0. The force F^{→}_{DC} may be produced by environmental phenomena such as wind or by an impact resulting in this case from a vehicle leaving the road.

If, when the building vibrates or if the position thereof is changed by a difference greater than a given threshold difference, the processing unit 18a then triggers a warning for the user. The warning may be a message (SMS, email, etc.). The purpose of the warning is to alert the user that the structural state of the building is failing and requires consolidation intervention. Of course, if the difference is extreme, an urgent alert can be parameterized requiring a rapid visit to the site of the structure.

Advantageously, the monitoring method may comprise a predictive step. The predictive step is performed by a learning algorithm which stores the cross-checked data and formulates predictive models in accordance with the cross-checked data over a defined monitoring period for one or more structures.

1. A device for measuring the structural state of a building, comprising:
at least one reference module; and
means for measuring movement of a target relative to the reference module,
wherein the measuring means comprises means for detecting movement of the target in a three-axis reference system,
wherein the means for detecting comprises:
a vibration sensor measuring the vibrations of the building,
wherein the movement measuring means comprises a resilient polymer cable conducting with variable resistivity, the polymer cable, connecting the reference module and the target while being kept under voltage, and
wherein at least one of a group consisting of: the reference module and the target comprises at least one resistivity sensor cooperating with the polymer cable.

2. The device for measuring, according to claim 1, further comprising: a protection sheath providing a confined measuring space in which the polymer cable extends.

3. The device for measuring, according to claim 1, wherein the reference module and the target comprise a fastening support allowing said modules to be securely connected to a wall of the building of which the structure must be monitored.

4. The device for measuring, according to claim 1, wherein the target is comprised of a fastening support or by a target module.

5. The device for measuring, according to claim 2, wherein the measuring means comprises an electric information return cable which is connected to the polymer cable and extends between the fastening support, and wherein the electric cable is rolled around the polymer cable or incorporated in the protection sheath.

6. The device for measuring, according to claim 4, wherein the module is defined by a rigid casing which is impervious to water and to air.

7. The device for measuring, according to claim 6, wherein the casing is comprised of two half-shells rigidly connected to one another.

8. A method for monitoring at least one measurement of the structural state of a building, the method comprising the steps of:
implementing at least one measuring device according to claim 1.
parameterizing an initial state of at least one measuring device incorporating at least one vibration and/or movement sensor, each measurement generating data;
periodically reading at least one vibration and/or movement measurement by means of at least one measuring device generating vibration and/or movement data;
periodically transmitting the data generated to at least one processing unit remote from the measuring device;
comparing the vibration and/or movement data to the initial state of the measuring device; and
a warning if the vibration and/or movement data exceed a given threshold difference compared to the initial state of a measuring device.

9. The method for monitoring, according to claim 8, further comprising a step of coding data allowing the provenance of the data recorded to be identified according to:
the measuring device from which said data come;
the sensor that measured said data; and
the moment at which said data were measured.

10. The method for monitoring, according to claim 1, further comprising a step of sorting the data so as to arrange said data according to:
the measuring device from which said data come;
the sensor that measured said data; and
the moment at which said data were measured.

11. An installation for monitoring structural state of a building, comprising:
at least one measuring device according to claim 1, the at least one measuring device being provided with remote transmission means and a remote processing unit of the measuring device, the processing unit being suitable for receiving and classifying the data transferred according to:
the measuring device from which said data come;
the sensor that measured said data; and
the moment at which said data were measured.

12. The installation, according to claim 11, wherein the measuring device comprises at least one reference module associated with a target, the reference module and the target being connected by a polymer cable, whereas the target is formed by a target module or a fastening support.

13. The installation, according to claim 12, further comprising:
a relay unit:
a receiver for the data sent by the transmission means of at least one measuring device;
means for recording the data transmitted;
means for remotely transferring the data; and
autonomous electric power supply means and/or connection means to an external electric power supply.
